(19) United States
(12) Patent Application Publication
(10) Pub. No.: US 2025/0237403 A1
(43) Pub. Date: Jul. 24, 2025

(54) EVAPORATIVE COOLER CONTROL SYSTEM

(71) Applicant: Rex A. Eiserer, Austin, TX (US)

(72) Inventor: Rex A. Eiserer, Austin, TX (US)

(21) Appl. No.: 19/032,791

(22) Filed: Jan. 21, 2025

Related U.S. Application Data
(60) Provisional application No. 63/622,985, filed on Jan. 19, 2024.

(51) Int. Cl. F24F 11/72

(52) U.S. Cl. CPC F24F 11/72

(57) ABSTRACT

An evaporative cooling system comprises, in some embodiments, an enclosure, an air inlet that enables air to flow into the enclosure, an air outlet that enables air to flow out of the enclosure, and an atomizer positioned within the enclosure, wherein the atomizer receives water from a water source and generates a mist of the water within the enclosure. Air from the air inlet is circulated through the enclosure and thereby cooled by evaporation of the mist, and the cooled air is provided at the air outlet. The system includes a controller coupled to receive measurements of conditions relating to the operation of the system and to generate control signals that control operation of the atomizer, fan or other components of the system.

### CROSS-REFERENCE TO RELATED APPLICATIONS

This application claims a benefit of priority under 35 U.S.C. § 119(e) from U.S. Provisional Application No. 63/622,985, entitled “EVAPORATIVE COOLER,” which is fully incorporated by reference herein for all purposes.

### TECHNICAL FIELD

The invention relates generally to evaporative cooling systems and more particularly to evaporative cooling systems, some of which are medialess, some of which have housings that are transformable from a compact storage configuration to a larger operating configuration, and some of which have control systems for controlling the operation of the cooling system.

### BACKGROUND

Evaporative cooling systems have been available for many years. These systems operate by directing water onto an evaporative cooling medium and directing air over the evaporative cooling medium. As the air flows by or through the evaporative cooling medium, the water in or on the medium evaporates. The evaporation of the water cools the air, which can then be directed into a desired area (e.g., within a dwelling).

Evaporative cooling systems may be used to cool residential or commercial structures. A typical residential evaporative cooling system has a rigid enclosure that is located on the roof of the home. A fan is positioned within the enclosure. The enclosure has one or more sides that are open, except that they are covered by evaporative cooling media such as fibrous pads. A water circulation system pumps water to the top of the pads, where the water is allowed to drip onto the pads and to saturate the pads. When the fan is turned on, air flows into the enclosure through the pads and then flows through a duct into the home. As the air flows through the pads, heat from the air is absorbed by the water, causing the water to evaporate. This cools (and increases the humidity) of the e air in the enclosure in comparison to the air outside the enclosure.

Because evaporative cooling systems are dependent upon the evaporation of water to cool the air, their effectiveness is dependent upon the humidity of the air in the area in which they are used. The more humid the air, the less effective they are at cooling the air. Evaporative cooling systems are, however, advantageous in that they are generally simpler in design and less expensive to install, operate, and maintain than refrigerated cooling systems. Evaporative cooling systems can also be designed to be mobile, and relatively large evaporative cooling systems can be used effectively in temporary or emergency situations, or in large or relatively open areas.

Traditional evaporative cooling systems may be very useful in a number of situations, but they have some drawbacks. One significant disadvantage, particularly with respect to systems that are intended to be transportable, is that they may require a relatively large amount of space during operation and storage. For instance, typical portable evaporative cooling systems have large, rigid shrouds that provide a large area for the cooling medium and funnel the cooled air from the cooling medium to the fan. While it is desirable for the cooling medium to cover more area in order to provide more effective cooling, the larger the cooling area is, the more difficult it is to store and/or transport the system.

It would therefore be desirable to provide evaporative cooling systems that are more easily stored and transported than conventional systems.

### SUMMARY OF THE INVENTION

This disclosure is also directed to systems and methods for evaporatively cooling air that solve one or more of the problems discussed above. One embodiment of an evaporative cooling system includes an enclosure, an air inlet that enables air to flow from an exterior of the enclosure to an interior of the enclosure, an air outlet that enables air to flow from the interior of the enclosure to the exterior of the enclosure, a mist source positioned within the enclosure, wherein the mist source receives water from a water source and generates a mist of the water within the enclosure, wherein air from the air inlet is passed through the enclosure and thereby cooled by evaporation of the mist, and the cooled air is provided at the air outlet, and a controller operatively coupled to the cooling system, wherein the controller generates one or more control signals that control the operation of the cooling system.

One particular embodiment comprises an evaporative cooling system that has an enclosure which is alternately expandable and contractible. With the housing expanded, the system can be operated to cool air that flows through the system. When the system is not being operated, the housing can be contracted so that the system is more easily stored or transported. In this embodiment, the system includes a water reservoir that is contained within the enclosure. An air inlet enables external air to flow into the interior of the enclosure. An air outlet enables the air to flow out of the enclosure to the exterior of the enclosure. One or more evaporative media are positioned within the enclosure so that air can flow over them. A water distribution subsystem is also positioned within the enclosure to circulate water from the water reservoir to the evaporative media. The water distribution subsystem may include a pump that circulates water from the water reservoir through tubing within the enclosure to the evaporative media. A fan is coupled to the enclosure so that when the fan is operated, it causes air to flow into the enclosure through the air inlet, through the one or more evaporative media and out of the enclosure through the air outlet. As the air flowing over or through the evaporative media, the air is cooled by evaporation of water from the media.

When the enclosure is contracted, the enclosure occupies a first, reduced volume. This makes the system more compact to facilitate transportation and storage of the unit. When the enclosure is expanded, the enclosure occupies a second, greater volume. The evaporative media and the water distribution subsystem in this embodiment are connected to a collapsible support structure within the enclosure so that they are movable from a first, compact position when the enclosure is contracted to a second, operating position when the enclosure is expanded. The enclosure may have one or more substantially rigid shell portions that form a protected volume for the evaporative media and the water distribution subsystem when the enclosure is contracted. The shell portions may include upper and lower shell portions, where the water reservoir is formed in the lower shell portion. The reservoir formed in the lower portion may have a layer of thermal insulation that can be accessed to place ice in the reservoir. The ice may directly cool air that flows over it, and may also cool the water that is distributed to the evaporative media, thereby cooling the air that flows over and around the media. The system may have various additional features. For example, some embodiments may include an ozone generator which is configured to generate ozone in the water that is circulated through the system. The ozone generator may saturate the water with ozone and produce additional ozone that is combined with the air which flows through the enclosure. The ozonated water and/or air can then be circulated through the system to disinfect the housing and evaporative cooling media as well as the air and water themselves.

An alternative embodiment comprises a method for providing evaporative cooling. This method includes providing an evaporative cooler enclosure that is alternately expandable and contractible. This enclosure houses evaporative media and a water distribution subsystem. The enclosure is initially in a contracted position which is suitable for transportation or storage of the system. The various cooling system components that reside within the enclosure may be in compact storage positions. The enclosure is then moved to an expanded position, which causes the evaporative media and the water distribution subsystem to move from their compact storage positions to operating positions. With the system components in the expanded operating positions, water is circulated through the water distribution subsystem to the evaporative media. Air is circulated through the evaporative media within the enclosure, thereby cooling the air that is circulated through the enclosure. The air may be disinfected by ozonation or other means as it is circulated through the enclosure. This may be accomplished by generating ozone within the water in the system. The air may also be cooled by causing it to flow over ice in the reservoir, or by using ice to cool the water that is distributed to the evaporative cooling media. When the system is no longer needed, circulation of water through the water distribution subsystem and the one or more evaporative media can be discontinued and circulation of air through the enclosure can be stopped. The enclosure and the contained cooling components are then moved from the expanded position to the contracted position.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating the principle of operation of evaporative cooling systems.

FIG. 2 is a diagram illustrating an exemplary residential rooftop evaporative cooling system having a rigid, substantial cubic housing.

FIG. 3 is a diagram illustrating an exemplary portable evaporative cooling system having a rigid housing.

FIG. 4 is a diagram illustrating an exemplary evaporative cooling system having a collapsible/expandable housing in accordance with one embodiment.

FIG. 5 is a diagram illustrating an exemplary evaporative cooling system having a collapsible/expandable housing in the shape of a palm tree in accordance with one embodiment.

FIG. 6 is a diagram illustrating an exemplary evaporative cooling system having a collapsible/expandable housing that forms an inflatable tent or protective structure in accordance with one embodiment.

FIG. 7 is a diagram illustrating the connection of a first part of a housing to a second part of the housing, where the first part contains components of an evaporative cooling system, and the second part forms an inflatable structure through which cooled air is distributed.

FIG. 8 is a diagram illustrating an exemplary portable evaporative cooling system in which the system's housing is connected to inflatable ducting that unrolls when the system is used and can be rolled up and stored with the evaporative cooling system when not in use.

FIG. 9 is a diagram illustrating an exemplary portable evaporative cooling system in which the system's housing is connected to removable/inflatable ducting that can be suspended from a roof or other structure to provide cooled air from above an area such as an outdoor dining patio.

FIG. 10 is a diagram illustrating an example of an evaporative cooling system that does not use evaporative media in accordance with some embodiments.

FIG. 11 is a diagram illustrating a control system in accordance with some embodiments.

FIG. 12 is a flow diagram illustrating a method in accordance with some embodiments.

FIGS. 13-14 are diagrams illustrating examples of an evaporative cooling system that operates without evaporative media in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined herein. Further, the drawings may not be to scale, and may exaggerate one or more components in order to facilitate an understanding of the various features described herein.

### DETAILED DESCRIPTION

One or more embodiments of the invention are described below. It should be noted that these and any other embodiments described below are exemplary and are intended to be illustrative of the invention rather than limiting.

One exemplary embodiment of the present invention comprises an evaporative cooling system that has an expandable housing. When the system is not in use, the housing is collapsed to a smaller size so that it is more easily stored or transported. When the system is in use, the housing is expanded to a larger size, opening or expanding air flow pathways through the housing and the evaporative cooling media that are mounted on or in the housing. A water distribution system is provided to deliver water to the evaporative cooling media. A fan is also provided to draw air through the evaporative cooling media.

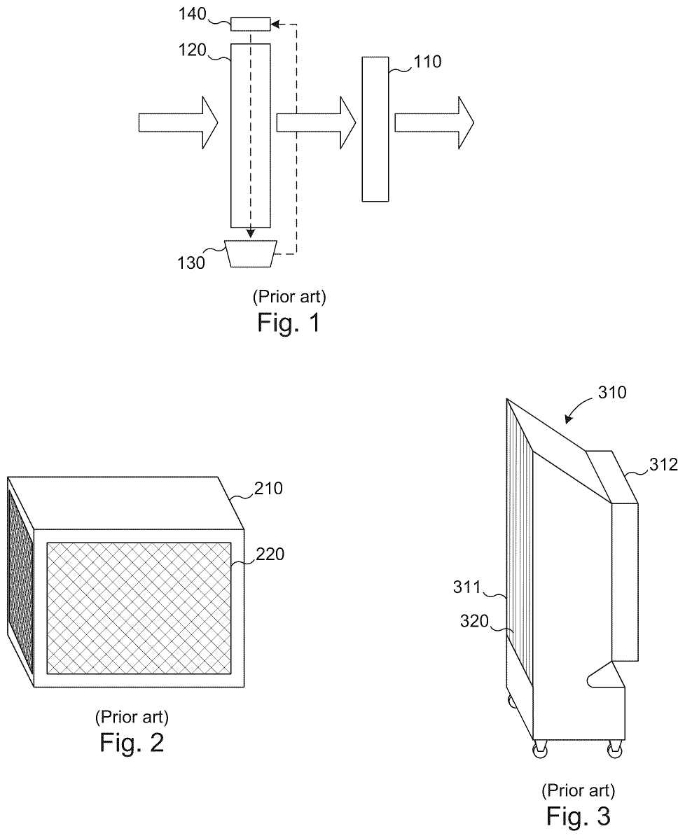

Referring to FIG. 1, a functional block diagram illustrating the principle of operation of evaporative cooling systems is shown. As depicted in this figure, a fan 110 draws air through an evaporative cooling medium 120. A water circulation system pumps water (as indicated by the dashed line) from a water source such as reservoir 130 to a manifold 140. Water flows out of manifold 140 onto evaporative cooling medium 120. The water moistens the medium and, as the air flows through the medium, the water evaporates and cools the air. Water that is not evaporated continues to flow downward through evaporative cooling medium 120, and is collected in reservoir 130. The collected water is then recirculated to manifold 140, from which it can again flow onto and through evaporative cooling medium 120.

Alternative embodiments may use varying components. For example, in the embodiment above, the fan is driven by an electric motor. The fan's motor may be powered by a battery, a generator or any other means. The fan may alternatively be driven by a combustion engine in other embodiments. The pump of the water distribution system is also driven by an electric motor in this embodiment. The pump motor may be powered by batteries, generators or other means. The water distribution system may alternatively be a non-recirculating system that distributes water from a source such as a garden hose or water storage unit, rather than pumping the water out of a reservoir which collects water that runs off from the evaporative cooling media. In a recirculating water distribution system, the reservoir may be a rigid structure, or it may be a flexible structure, such as a bladder.

Although not explicitly depicted in FIG. 1, the components of the evaporative cooling system are normally mounted to a rigid housing. The housing holds the evaporative cooling medium in position as the fan pulls air through it. The housing also supports the water distribution system so that it is properly positioned to direct the water onto the evaporative cooling medium.

Conventional evaporative cooling systems can be configured in various ways. One of the most common configurations is a residential rooftop installation. An exemplary system is depicted in FIG. 2. This illustration shows the housing 210 of the cooling unit with the evaporative cooling media 220 installed in the outer walls of the housing. Commonly, housing 210 has a simple, quasi-cubic shape and is constructed of stamped sheet metal. The housing typically has openings in either three or four sides, and the evaporative cooling media are installed in the openings. The bottom of the housing forms a reservoir for the water distribution system, and a pump is mounted within the housing to pump water from the reservoir to the tops of the evaporative cooling media. A fan is also mounted within the housing to draw air into the housing through the evaporative cooling media. The fan is coupled to a duct that extends through the rooftop into the building, so air that is drawn into the unit through the evaporative cooling media (thereby cooling it) and then blown into the home through the duct.

Another common configuration for a conventional evaporative cooling system is a portable unit. An exemplary portable evaporative cooling system is shown in FIG. 3. In this system, the housing 310 is a large structure that is commonly made of a rigid plastic such as PVC. The housing typically has a single large opening 311 on a first, inflow side of the unit, and a second, smaller opening 312 on the opposite, outflow side of the unit. Inflow opening 311 is typically larger because the evaporative cooling medium 320 is positioned within this opening, and it is desirable to maximize the area of the evaporative cooling medium in order to maximize the cooling effect of the medium. The unit's fan (which is not visible in the figure) is positioned within the second opening 312. The body of the housing typically tapers from the larger opening 311 to the smaller opening. When the fan operates, it pulls air through evaporative cooling medium 320 in opening 311 and blows the air out of opening 312. As with the residential unit, a pump is provided to draw water out of a reservoir which is integrated into the lower portion of the housing and deliver the water to the top of the evaporative cooling medium. The water flows downward through the evaporative cooling medium, and the air flowing through the evaporative cooling medium is cooled by evaporation of the water. Wheels are attached to the housing below the reservoir to allow the unit to be rolled from one location to another.

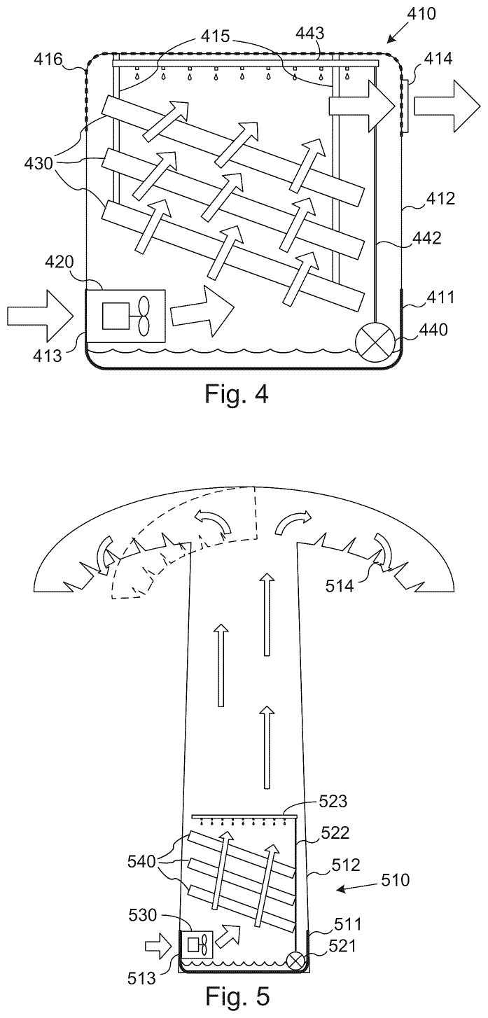

Referring to FIG. 4, a diagram illustrating the structure of an exemplary embodiment of the present invention is shown. In this embodiment, an evaporative cooling system 400 includes a housing or enclosure 410, a fan 420, evaporative cooling media 430, and a water distribution system. The primary difference between this embodiment and conventional evaporative cooling systems is that housing 410 is expandable and collapsible, rather than being a rigid structure that does not change its shape. During operation, cooling system 400 is in an expanded position that allows air to flow through pathways within the housing from the inlet to the outlet. These air flow pathways occupy a certain amount of empty volume. In a conventional evaporative cooling system, the rigid, unchanging shape of the housing maintains this empty volume, whether the system is in use or not. In the present systems, the housing can be collapsed when not in use, thereby reducing or eliminating the empty volume within the housing. By reducing or eliminating the empty space in the housing, the overall volume occupied by the system is reduced, which makes the system easier to store and/or transport.

In the embodiment of FIG. 4, housing 410 includes a rigid or semi-rigid lower portion 411 and a flexible upper portion 412. Lower portion 411 may be formed from PVC or other plastics. Lower portion 411 forms a tray or shallow tub that functions as a reservoir for water that flows through the evaporative cooling media. The reservoir formed in the lower portion may have a layer of thermal insulation 417. This tray may also serve as all or part of the shipping and storage container for the system when not in use. In an alternative embodiment, the tray portion of the system may also be flexible (e.g., made of a waterproof fabric) that can be folded or collapsed. Upper portion 412 may be constructed from a fabric or similar flexible material. The lower edge of upper portion 412 is connected to the upper edge of lower portion 411. Fan 420 is mounted to the lower portion 411 of the housing at an inlet to the housing. Fan 420 forces air into the housing, generating a positive pressure differential between the interior and exterior of the housing. This positive pressure differential (where the air pressure inside the housing is greater than the air pressure outside the housing) causes the housing to move to its expanded position when the fan is operating. Effectively, the fan inflates the housing. By contrast, conventional evaporative cooling systems typically position the fan at the air outlet so that operation of the fan creates a negative pressure differential that pulls air into the housing. With a negative pressure differential, the housing must be rigid in order to keep it from collapsing. It should be noted that alternative embodiments of the present invention may use a collapsible rigid housing. For instance, the housing may have rigid walls that fold into a collapsed position for storage and transport, or into an expanded position for operation of the cooling system. When a rigid collapsible housing is used, a positive internal pressure differential may not be necessary, and the fan may be positioned at an outlet in the housing.

The embodiment of FIG. 4 includes multiple evaporative cooling media 430. These media may, for example, be fibrous pads or other suitable media. The media are arranged within the housing so that when the housing is in its expanded position, there is space between the media. The media are positioned between the fan at the inlet 413 to the housing and the outlet 414 of the housing so that when the fan is operating, the air is forced through each of the media before exiting the housing. Because the air interacts with multiple media, the maximum cooling effect is achieved (compared to a single media interaction like conventional coolers).

The water circulation system includes a pump 440 that draws water from the reservoir in the lower portion 411 of the housing and pumps this water through one or more tubes 442 to a manifold 443 that delivers the water to evaporative cooling media 430. The water may be sprayed, dripped, or otherwise delivered to the evaporative cooling media. The portion of the water that flows through the media and is not evaporated is collected in the reservoir and is then recirculated. In some alternative embodiments, passive mechanisms may be used to deliver the water to the evaporative cooling media. For example, a wicking mechanism (which uses capillary action to draw the water from the reservoir) may be used, or an inlet fan may create water droplets that are blown onto the evaporative cooling media. In one embodiment, the housing is configured so that, after passing through the evaporative cooling media, the speed of the cooled air is reduced to a level at which water droplets are allowed to fall out of the air before it exits the housing. This prevents the system from producing an undesirable mist, and it also enables the system to provide effective cooling for a longer period of time since more water is retained within the housing.

The media may be hinged or otherwise configured so that when the housing is in the collapsed position, the media are more closely positioned (e.g., stacked on top of each other) and require less space in the housing. In the embodiment of FIG. 4, each of evaporative cooling media 430 is supported by a plurality of straps or cables 415 that extend downward from the top of the housing. When the housing is moved to the collapsed position, the top of the housing moves downward, lowering the straps so that the evaporative media rest on each other within lower portion 411 of housing 410. The components of the water distribution are also configured to move with the expansion and contraction of the housing. In one embodiment, the pump is mounted in a fixed position in the lower portion of the housing and flexible tubing coupled to the pump extends to the top of the housing. A manifold (e.g., perforated tubing that is attached to the top of the housing) receives water from the pump through the flexible tubing and distributes the water across the evaporative cooling media.

It is not unusual for mold growth and bacterial growth to occur in moist environments such as evaporative cooling systems. The present system may therefore incorporate means to prevent mold growth. In one embodiment, an ozone generator 450 is positioned within the housing at the air inlet and/or in the water collection section of the system. When ozone is generated in the air, it flows through the housing and through the evaporative cooling media with the air as it is being cooled. In some embodiments, the water that is circulated through the distribution system and evaporative cooling media is ozonated. In both cases, the ozone in the air and/or the ozonated water is circulated through the system, thereby disinfecting the housing and evaporative cooling media. Other means to combat mold and bacteria may also be used.

The housing may have many different configurations. As described in connection with FIG. 4, the Housing has a rigid lower portion and a flexible fabric upper portion. In one alternative embodiment, the upper portion may comprise several rigid but movable components. For instance, the vertical walls of the housing may be hinged so that they fold together (accordion-style) when the housing is in its compact state. The walls components may alternatively be movable with respect to each other (e.g., telescoping) so that they occupy different positions in the housing's operating and compacted states. In another embodiment, the housing may have rigid upper (416) and lower (411) portions with a flexible intermediate portion connected between them. In this embodiment, when the housing is in its expanded state, the intermediate portion is extended between the upper and lower portions, and when the housing is in its compacted state, the intermediate portion collapses to allow the upper and lower portions to come together to form a suitcase-like shell. Alternatively, the system could employ a collapsible frame that supports the top or body portions of the housing. Any or all of these embodiments may include features such as wheels and stowable handles on the housing and to facilitate movement or transport of the systems. The housing components may include rigid, semirigid and flexible components in any combination.

While the housing depicted in FIG. 4 is generally rectangular, alternative embodiments may have many different shapes. In particular, the housing can include a flexible fabric portion that takes on shapes which would not be practical in a conventional system. For example, as depicted in FIG. 5, one embodiment of an evaporative cooling system uses a housing that has the form of a palm tree. In this embodiment, the housing 510 includes a lower portion 511 and an upper portion 512. Lower portion 511 is similar to the lower housing portions described above, in that it is made of a substantially rigid material that forms a reservoir for a water circulation system, and has a pump 521 for the water circulation system mounted to it. A fan 530 is also mounted to lower housing portion 511 at an inlet 513 to force air into housing 510.

The upper portion 512 of the housing in this embodiment is made of a lightweight fabric (e.g., nylon). Upper housing 512 has the shape of a tree (e.g., a palm tree), including a trunk portion that is attached at its lower end to lower housing portion 511, and one or more branch/leaf portions that extend outward from the trunk portion. Several evaporative cooling media 540 are positioned within the trunk portion of the housing. A water distribution tube 522 extends from pump 521 to a water distribution manifold 523 that is positioned at the top of the evaporative cooling media.

When fan 530 is operated, it forces air from inlet 513 into housing 510. The air pressure inside the housing causes the flexible housing to inflate and take on the tree shape. The air that is forced into the housing flows upward through evaporative cooling media 540 and is cooled by evaporation of the water in/on the media. The air continues to flow upward through the trunk portion of the housing and into the branch/leaf portion(s). Air outlets (e.g., 514) are provided in the branch/leaf portions so that the cooled air is distributed to the area around the housing, particularly under the branch/leaf portion of the housing.

When the fan is not being operated, it no longer produces a positive pressure differential between the interior and exterior of the housing, so the upper fabric portion of the housing deflates. It should be noted that the evaporative cooling media 540 and the water distribution system (particularly the tubing and manifold portions) are movably mounted within housing 510 so that they move into a compact position when the upper portion of the housing deflates. This allows the overall volume of the evaporative cooling system to be reduced, making it easier to store and/or transport the system.

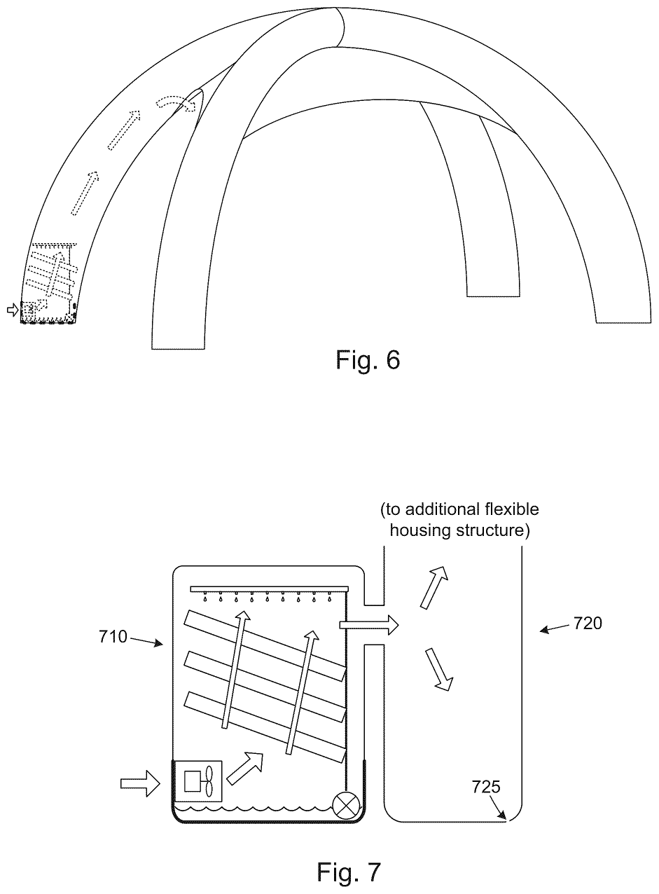

Another alternative embodiment is shown in FIG. 6. In this embodiment, an evaporative cooling system includes a housing that forms a tent or other type of shelter when the system is in operation. The housing includes an upper portion made of a flexible (e.g., nylon) fabric that is inflated when the fan of the evaporative cooling system is turned on. Air that is cooled by the system flows out through air outlets (in an upper part of the tent portion so that the cooled air is directed onto the area under the tent. When the fan is turned off, the portion of the housing forming the tent collapses, enabling the convenient storage and/or transportation of the system.

Components of the system such as the fan, air inlet, reservoir, water distribution system, and the like may, for example, be located in the bottom of one of the legs of the tent, similar to the location at the bottom of the trunk portion of the system of FIG. 5. Alternatively, these components may be located in a portion of the housing that forms a separate structure that is adjacent to the flexible portion of the housing and forces cooled air into the flexible portion of the housing. This configuration is illustrated in FIG. 7, which shows the fan, air inlet, reservoir, water distribution system, etc. in a first portion 710 of the housing. The cooled air from portion 710 is forced by the air pressure inside this portion of the housing into the flexible tree/tent portion 720 of the housing. Portion 720 of the housing may include a weep hole 725 to allow mist which collects in this portion of the housing to escape from the housing.

In another alternative embodiment, multiple fans may be used, where at least one of the fans' primary function is to inflate the structure, while at least one of the other fans is used to provide the cooling air to the structure. In yet another alternative embodiment, a conventional inflatable tent or similar structure can be converted to a cooling system by inserting an evaporative cooling element (e.g., evaporative cooling media and water distribution subsystem) between the fan and the inflatable tent structure of the conventional system.

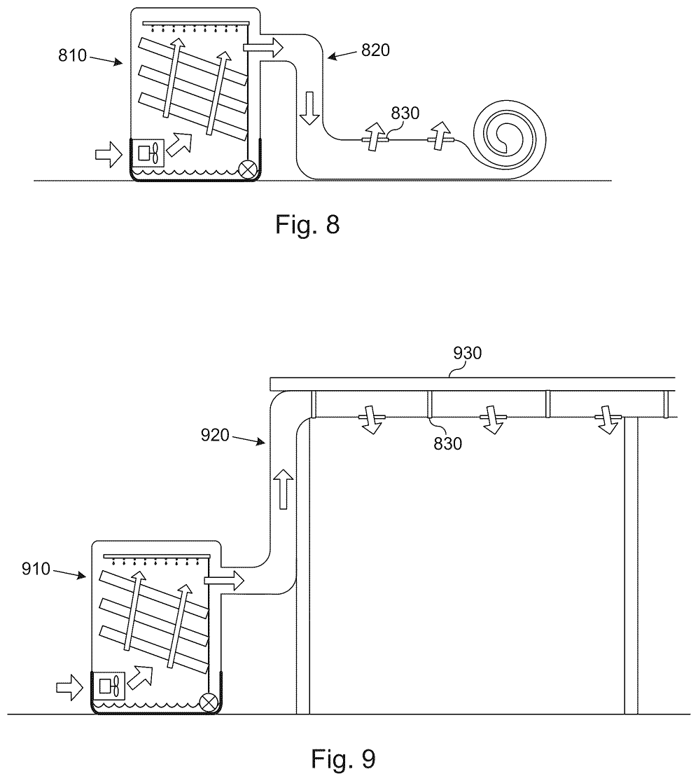

Referring to FIG. 8, a diagram illustrating an alternative portable evaporative cooling system is shown. In this embodiment, the system's housing 810 is connected to inflatable ducting 820 that unrolls when the system is used and can be rolled up and stored with the evaporative cooling system when not in use. The ducting can be made of a lightweight fabric that takes up very little space when it is rolled up, potentially allowing the ducting to be stored with the evaporative cooling system. The ducting has several outlets 830 along its length that allow the cooled air to be distributed through the duct to a desired area.

Referring to FIG. 9, a diagram illustrating another alternative embodiment is shown. In this embodiment, a portable evaporative cooling system 910 is connected to removable/inflatable ducting 920 that can be suspended from a roof 930 or other structure. This system provides cooled air from above the desired area without impeding access to the area being cooled, such as an outdoor dining patio. The ducting can be made of a fabric that can easily be supported by straps 940 or other means connected to the roof. The ducting can easily be installed as desired to meet the cooling requirements for the area. When the ducting is not in use, it is deflated and can easily be removed.

While the embodiments described above distribute water onto evaporative media to provide cooling of the air that is circulated through the systems, some alternative embodiments do not require evaporative media for this purpose. These alternative embodiments use an atomizer to generate a very fine water mist. Because the water droplets of the mist are very fine, they do not fall quickly to the bottom of the enclosure, but are instead effectively suspended within the enclosure by the air that flows through the enclosure. The increased surface area of the very small droplets also allows the water to evaporate more quickly. Still further, since the evaporative media are not required, the system may be capable of collapsing into a smaller volume than embodiments that use evaporative media.

A mist generator, mister, or mist source, etc., can take many forms. For the purposes of this description, the term atomizer will be used to refer to various devices and techniques for generating a mist. For example, an atomizer can be a water distribution system that sprays water into a moving airstream so the moving air breaks up the stream into discrete droplets. In another example, an atomizer can be a water distribution system that sprays water under pressure to break up the stream into discrete droplets at the nozzle as it enters the airstream. In another example, an atomizer can be vibrating devices that uses vibrations, like ultrasonic misters, that eject discrete droplets of water away from the water surface. In another example, an atomizer can be spinning devices, like controlled droplet applicators (CDAs) that use centrifugal forces to separate a water stream into discrete droplets. Various other devices or techniques can also be used to generate a mist, as one skilled in the art would understand.

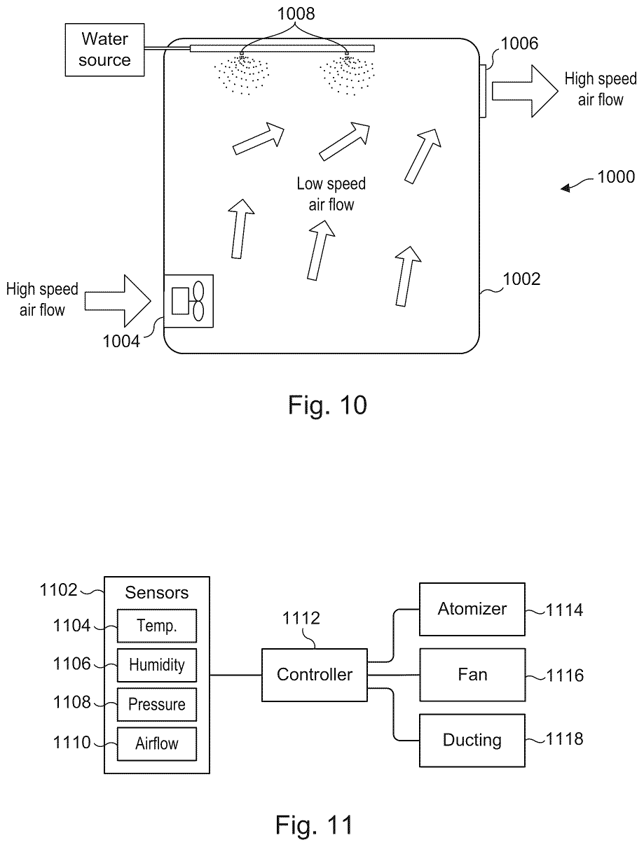

Referring to FIG. 10, an example of an evaporative cooling system that does not use evaporative media is shown. In this embodiment, the enclosure 1002 of cooling system 1000 includes an inlet fan 1004 that forces air into the enclosure and a cooled air outlet 1006 from which the air exits the enclosure. As in the embodiments described above, the pressure of the air forced into enclosure 1002 may be used to expand the enclosure from its collapsed position. In alternative embodiments, however, the enclosure may be expanded manually without the assistance of the forced air.

At the top of enclosure 1002 are a set of atomizers or misters 1008. Atomizers 1008 may be ultrasonic atomizers, ultrafine spray misters, or any other suitable mechanism to generate the desired size of water droplets in the mist. Atomizers 1008 receive water from a water source and generate a fine mist of water droplets which are sprayed into the enclosure. While atomizers 1008 may be located at various different positions within enclosure 1002, it is generally beneficial to position the atomizers near the top of the enclosure since gravity will tend to draw the droplets downward.

It is further generally beneficial to position inlet fan 1004, or more specifically the air inlet to the enclosure, near the bottom of enclosure 1002 with the air outlet near the top of the enclosure. This generates an upward component of the air flow through the enclosure, which tends to drive the water droplets upward, against the pull of gravity. The air flow's effect of suspending the water droplets (or slowing the fall of the droplets through the enclosure) is dependent upon a number of different factors, such as the size of the water droplets, the rate of air flow through the enclosure and the speed of the air as it flows through the enclosure.

If the droplets are smaller, the droplets may completely evaporate before reaching the floor of the enclosure. In this case, it may not be necessary to provide any means for collecting and/or recirculating the water. By eliminating the need for water collection and/or recirculation means, the cost, complexity and size of the system may be reduced. It should be noted, however, that if the atomized droplets are small enough to completely evaporate, but the volume of water that is atomized is less than the maximum amount that could be evaporated under the prevailing conditions, the system will not achieve the maximum cooling that is possible under the conditions. In other words, more water could have been evaporated, and greater cooling could have been achieved. Some embodiments therefore implement controls to sense relevant conditions and adjust the operation of the cooling system to try to maximize the cooling provided by the system.

Referring to FIG. 11, a functional block diagram illustrating a control system in accordance with some embodiments is shown. In this embodiment, multiple sensors are employed to measure a variety of different parameters relevant to the operation of the cooling system. Sensors 1102 include temperature sensors 1104, humidity sensors 1106, airflow sensors 1108, pressure sensors 1110, etc. The sensors may measure parameters both within the enclosure and external to the enclosure. The types and placement of sensors included in the figure are intended to be illustrative, rather than limiting, and other types of sensors may be used as well. Conversely, not all of these sensors are required, and some embodiments may use fewer sensors than are depicted in the figure. Other types of sensors that could be used include, for example, water level sensors (for water supplies or reservoirs), vent/door sensors (for sensing whether a vent, door, valve, etc. is open or closed), mist/water droplet sensors, etc., as one skilled in the art would understand.

Sensors 1102 are coupled to provide measurement data to a controller 1112. Controller 1112 processes each of these inputs from the sensors and generates control signals that are output to add atomizer 1114, inlet fan 1116 and ducting 1118. The control signals are adapted to adjust the operation of these components to adjust the operation and/or performance of the system (e.g., to maximize the cooling of the system, adjust the humidity of the output air, etc.) For example, if a signal received from a humidity sensor indicates that the humidity of the air external to the cooling system is high, a lower percentage of the water sprayed by the atomizer may evaporate as the droplets fall through the cooling system enclosure. The controller may therefore reduce the amount of water that is provided to the atomizer for generation of the mist within the enclosure. On the other hand, if the humidity sensor indicates that the humidity of the external air is very low, a higher percentage of the water sprayed into the enclosure by the atomizer may evaporate, so the controller may increase the amount of water provided to the atomizer.

Another benefit of a controllable system is that it can minimize the amount of water wasted as unevaporated droplets or mist in the airflow once the air is saturated. This also benefits in that people or objects downstream in the airflow do not get wet from the unevaporated excess water. Another benefit of the controllable system is that it allows for an evaporative cooler to be used as humidifier in a deliberate and controllable manner, which is not currently possible with evaporative coolers.

Controller 1112 similarly uses inputs from the other sensors to generate control signals which are output to atomizer 1114, inlet fan 1116, and any other components that may be controlled by controller 1112 (e.g., valves, recirculating pumps, controllable ducts, vents, doors, etc.). It should be noted that controller 112 may use any suitable the algorithms or methodologies to generate the control outputs. These algorithms are not described in detail herein because the particular algorithm that is used in a given embodiment is not important to the patentability of the embodiment. Note that the controller can be physically located in different places, as desired. For example, a controller can be a part of the cooling system, as well as being located remotely, while still being operatively connected to the sensors and various other components of the cooling system. A controller can be connected to the components of a cooling system via a wired connects as well as wirelessly.

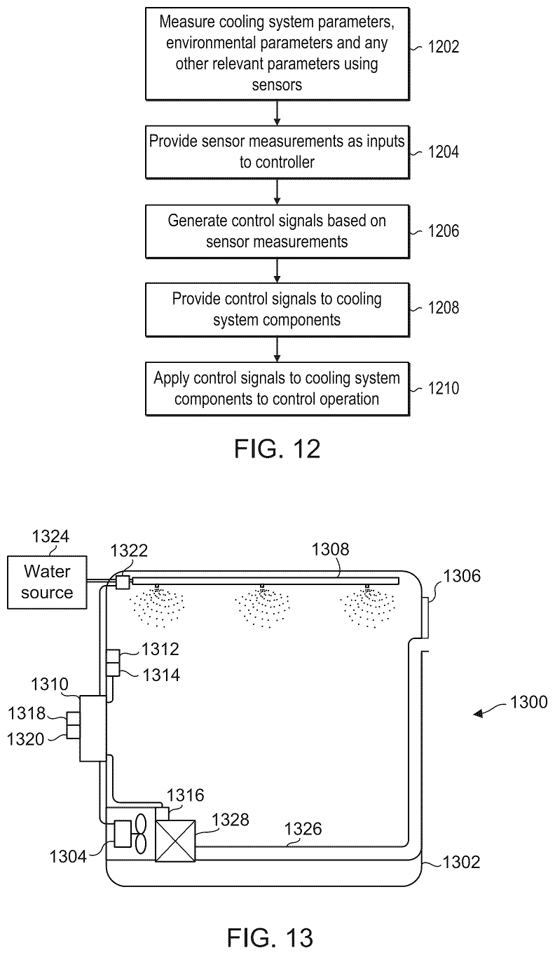

Referring to FIG. 12, a flow diagram illustrating a method in accordance with one embodiment is shown. In this method, measurements of one or more parameters or conditions relevant to the operation of the cooler are taken by one or more corresponding sensors (1202). These parameters may include, for example, cooling system parameters (e.g., air flow, fan speed, water flow), environmental parameters (e.g., humidity and temperature) and any other relevant parameters.

These measurements of the various parameters are provided by the sensors as inputs to the controller (1204). In addition to the sensor signals that are provided to the controller, one or more user inputs may be provided to the controller to enable the user to manually adjust the operation of the cooling system. For example, the system may have manual controls to adjust a level of cooling (low/medium/high), a fan speed, a target temperature, a target humidity level, or some other operating parameter.

The controller then uses the received inputs representative of the operating parameters to generate a set of control signals (1206). The controller then provides the generated control signals to one or more of the components of the cooling system (1208), such as the inlet fan or the atomizer. The control signals are applied to the respective ones of the cooling system components to control the operation of these components (1210), such as changing the speed of the inlet fan to adjust the flow rate of air through the cooling enclosure, changing the flow rate of water to the atomizer to adjust the volume of water mist that is generated by the atomizer, opening/closing/adjusting doors or vents or bypasses to affect air flow, changing the operation of pumps/valves (e.g., for different water sources) based on sensed conditions such as water levels, etc. The operation of the cooling system can also be changed based on mist droplets (size density, etc.). For example, if there is excess mist (e.g., exiting the outlet), the mister can be controlled to reduce the amount of mist produced. Or, if the droplets are too large, the mister can be adjusted to form smaller droplets.

Referring to FIG. 13, another example of an evaporative cooling system that operates without evaporative media is shown. In this embodiment, cooling system 1300 has an enclosure 1302 with an inlet fan 1304 at or near the bottom of the enclosure that forces air into the enclosure and an air outlet 1306 at or near the top of the enclosure that allows the air to exit the enclosure. An atomizer 1308 at or near the top of the enclosure is fed by a water source and is configured to generate a water mist within the enclosure. As air flows from the inlet to the outlet, it flows upward against the falling mist so that the mist evaporates and cools the air before it exits the enclosure.

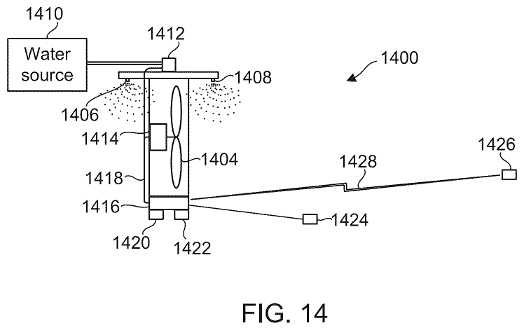

While the embodiment of FIG. 13 uses an enclosure within which the water is evaporated into the air flow, alternative embodiments need not use such an enclosure. For example, one alternate embodiment may use an open fan with an atomizer or mister that injects water droplets into the air flow created by the fan. The operation of the fan (e.g., fan speed) and atomizer/mister (e.g., water flow/output) are controlled based on the outputs of sensors (e.g., humidity, temperature) that are provided to a control system that generates control signals to adjust the operation of the fan and atomizer/mister. An example of such an embodiment is provided in FIG. 14.

In this embodiment, a controller 1310 is coupled to atomizer 1308 and inlet fan 1304 to control operation of these components. In this case, controller 1310 controls a valve 1322 that controls the flow of water from water source 1324 to atomizer 1308. Controller 1310 also controls a ducting valve 1328 that can be adjusted to direct airflow through ducting 1326, as well as through the interior of enclosure 1302. Ducting valve 1328 determines the percentage of the airflow that flows through ducting 1326 and the percentage airflow that flows through enclosure 1302 and can thereby affect the amount of cooling or humidification that is achieved by evaporating water into the air flowing through the enclosure.

Controller 1310 is further coupled to a set of sensors that are located internal to and external to enclosure 1302. In this embodiment, the sensors include internal temperature sensor 1312 and humidity sensor 1314, airflow sensor 1316, and external temperature sensor 1318 and humidity sensor 1320. Although not explicitly depicted in the figure, controller 1310 may also have user controls (e.g., temperature settings, cooling level settings, fan settings, etc.) that allow a user to select various options for the operation of the cooling system. Controller 1310 uses the inputs from the sensors and user controls to compute control outputs for atomizer 1308 and fan 1304 (or any other controllable components of the cooling system). The user controls can take any form desired, such as a control panel, an electronic interface or touch screen, a web interface, etc.

Referring to FIG. 14, an alternative embodiment of an evaporative cooling system that operates without evaporative media is shown. In this embodiment, cooling system 1400 operates without an enclosure. The cooling system has a fan 1404 that is mounted on a structure that may leave the area around the fan almost completely open, or it may have a shroud that surrounds the periphery of the fan to help direct the airflow through the fan.

A set of atomizers or misters 1406, 1408 (which are at the top of the cooling system in this figure, but may be positioned in alternative locations in other embodiments) receive water from a water source 1410 through a controllable valve 1412. Controllable valve 1412 and fan motor 1414 are controlled by control signals received via control lines 1418 from a controller 1416.

Controller 1416 is also connected to a set of sensors that provide feedback to the controller as to the cooling effects of the system. In this embodiment, two sensors 1420, 1422 are connected to the cooling system at or near fan 1404 to measure local parameters, such as the temperature and humidity in the immediate vicinity of the cooling system. A third sensor 1424 may be positioned remotely from the cooling system to measure one or more conditions at a distance from the cooling system. Sensor 1424 is connected to controller 1416 by a physical communication line. This embodiment also includes a remote sensor 1426 that is coupled to controller 1416 by a wireless communication channel, which may allow the sensor to be conveniently positioned to sense environmental conditions without being hindered by a physical connection to the controller. This type of sensor may be particularly useful in scenarios where it is desired to achieve a desired temperature or humidity level in a room or area, rather than simply maximizing the cooling effect of the evaporative cooler.

There may be various alternative placements of the sensors depending on what output or control of the system is required to produce intended results. For example, in the example embodiments, the sensors may be placed in the inlet airstream, outlet airstream, in the immediate vicinity of the cooling system, and/or in the area that is being cooled or humidified. Note that sensors can be placed anywhere desired, including internally or externally to a cooler. In addition, note that sensors can be placed in any type of cooler, for example, coolers with enclosures and with media, coolers with enclosures but no media, coolers without enclosures, etc. If sensors are placed in the outlet airstream, characteristics of the outlet airstream can be controlled. If sensors are placed in the local area, then the control of the local area can be controlled. If sensors are placed in an area remote from the cooling system, then the control of the larger area around the system can be controlled.

There may be various alternative atomizer-based embodiments. For example, one alternative embodiment comprises an evaporative cooling system having an enclosure with an air inlet that enables air to flow into the enclosure and an air outlet that enables air to exit the enclosure. An atomizer is positioned within the enclosure, where the atomizer receives water from a water source and generates a water mist within the enclosure. Air from the air inlet is circulated through the enclosure and is cooled by evaporation of the mist before being provided at the air outlet.

In some embodiments, the atomizer and the air outlet are positioned at or near the top of the enclosure and the air inlet is positioned at or near the bottom of the enclosure, so that the mist falls through the enclosure, while flows upward through the enclosure.

In some embodiments, the evaporative cooling system includes a controller coupled to the atomizer and/or the inlet fan, wherein the controller generates one or more control signals that control operation of the atomizer and/or inlet fan. The controller may be configured to control a rate at which the atomizer injects the mist into the enclosure and/or to control a rate at which the fan causes air to flow through the enclosure.

In some embodiments, the evaporative cooling system includes one or more sensors coupled to the controller, where each of the sensors senses a corresponding parameter associated with operation of the evaporative cooling system and provides a corresponding sensor signal as an input to the controller, and where the controller generates the one or more control signals based at least in part on the received sensor signals. The one or more sensors may be configured to sense humidity, temperature, pressure, airflow, or other parameters associated with operation of the system. The sensors may be configured to sense parameters corresponding to conditions both internal and external to the enclosure. User controls may also be coupled to the controller, where each user control provides a corresponding user control signal as an input to the controller, and where the controller generates the control signals based at least in part on the received user control signals.

In some embodiments, the inlet fan generates high-speed air flow through the inlet to the enclosure and high-speed air flow at the outlet from the disclosure. The larger volume of the enclosure allows the air to flow more slowly upward from the lower portion of the enclosure to the upper portion of the enclosure. Since the air flows more slowly through the volume of the enclosure, the mist generated by the atomizers has more time to evaporate. The low-speed air flow also allows unevaporated droplets to fall out of the air, which enables the system to produce air at the outlet which is cooled, but which does not contain water droplets that can cause people using the system to feel sticky or uncomfortable.

In some embodiments, the enclosure has a portion that is alternately expandable and contractible, where when the first portion of the enclosure is contracted, the enclosure occupies a first volume, and when the first portion of the enclosure is expanded, the enclosure occupies a second volume that is greater than the first volume. The fan may be configured to force air into the enclosure to create a positive pressure differential between the interior of the enclosure and the exterior of the enclosure, thereby expanding the enclosure.

An alternative embodiment comprises a method for providing evaporative cooling, where an evaporative cooler enclosure is provided, air is drawn into the enclosure through an air inlet, a water mist is generated by an atomizer within the enclosure, and the air is circulated through the enclosure, where it is cooled by evaporation of the mist, so that cooled air is provided from an air outlet of the enclosure.

In some embodiments, the method includes sensing one or more parameters associated with operation of the evaporative cooling system, providing corresponding sensor signals as inputs to a controller, generating one or more control signals based at least in part on the received sensor signals, and providing the control signals to at least one of the atomizer and a fan that circulates the air through the enclosure. The sensed parameters may comprise one or more of: humidity; temperature; pressure; and airflow. The method may also include providing one or more user control signals to the controller and generating control signals based at least in part on the received user control signals, and providing the generated control signals to at least one of the atomizer and the fan.

It should be noted that the foregoing atomizer-based embodiments may include features that are disclosed in the previously described evaporative-media-based embodiments. For example, atomizer-based embodiments may use expandable/contractable enclosures, and may be coupled to inflatable structures such as those shown in FIGS. 5-9.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within this disclosure.

Embodiments may include, for example: an evaporative cooling system comprising: an enclosure; an air inlet that enables air to flow from an exterior of the enclosure to an interior of the enclosure; an air outlet that enables air to flow from the interior of the enclosure to the exterior of the enclosure; an atomizer positioned within the enclosure, wherein the atomizer receives water from a water source and generates a mist of the water within the enclosure; and wherein air from the air inlet is circulated through the enclosure and thereby cooled by evaporation of the mist, and the cooled air is provided at the air outlet.

Such an evaporative cooling system, wherein the atomizer is positioned at a top of the enclosure so that the mist falls through the enclosure; wherein the air inlet is positioned at a bottom of the enclosure; wherein the air outlet is positioned at the top of the enclosure; wherein the air from the air inlet flows upward through the enclosure to the air outlet.

Such an evaporative cooling system, further comprising a controller coupled to the atomizer, wherein the controller generates one or more control signals that control operation of the atomizer.

Such an evaporative cooling system, wherein the controller is configured to control a rate at which the atomizer injects the mist into the enclosure.

Such an evaporative cooling system, further comprising a fan positioned at the air inlet, wherein the controller generates one or more control signals that control operation of the fan.

Such an evaporative cooling system, wherein the controller is configured to control a rate at which the fan causes air to flow through the enclosure.

Such an evaporative cooling system, further comprising one or more sensors coupled to the controller, wherein each of the sensors senses a corresponding parameter associated with operation of the evaporative cooling system and provides a corresponding sensor signal as an input to the controller, wherein the controller generates the one or more control signals based at least in part on the received sensor signals.

Such an evaporative cooling system, wherein at least one of the one or more sensors is configured to sense humidity.

Such an evaporative cooling system, wherein at least one of the one or more sensors is configured to sense temperature.

Such an evaporative cooling system, wherein at least one of the one or more sensors is configured to sense pressure.

Such an evaporative cooling system, wherein at least one of the one or more sensors is configured to sense airflow.

Such an evaporative cooling system, wherein at least one of the one or more sensors is configured to sense parameters of droplets in the airstream, including, for example, droplet/mist size, velocity, direction, quantity, etc. This enables the ability to dial back (or increase) water injection, based on sensed conditions.

Such an evaporative cooling system, wherein the one or more sensors comprise a plurality of sensors, wherein a first portion of the plurality of sensors is configured to sense parameters corresponding to conditions internal to the enclosure and a second portion of the plurality of sensors is configured to sense parameters corresponding to conditions external to the enclosure.

Such an evaporative cooling system, further comprising one or more user controls coupled to the controller, wherein each of the user controls provides a corresponding user control signal as an input to the controller, wherein the controller generates the one or more control signals based at least in part on the received user control signals.

Such an evaporative cooling system, wherein the enclosure has a first portion that is alternately expandable and contractible, wherein when the first portion of the enclosure is contracted, the enclosure occupies a first volume, and when the first portion of the enclosure is expanded, the enclosure occupies a second volume that is greater than the first volume.

Such an evaporative cooling system, wherein the fan is configured to force air into the enclosure and thereby create a positive pressure differential between the interior of the enclosure and the exterior of the enclosure, thereby expanding the enclosure.

Another embodiment may include a method for providing evaporative cooling in an evaporative cooling system, the method comprising: providing an evaporative cooler enclosure; drawing air into the enclosure through an air inlet; providing water to an atomizer positioned within the enclosure, wherein the atomizer receives water from a water source and generates a mist of the water within the enclosure; circulating the air through the enclosure, wherein the air is cooled by evaporation of the mist; and providing the cooled air from the enclosure through an air outlet.

Such a method, further comprising sensing one or more parameters associated with operation of the evaporative cooling system; providing corresponding sensor signals as inputs to a controller; generating, by the controller, one or more control signals based at least in part on the received sensor signals; and providing the control signals to at least one of the atomizer and a fan that circulates the air through the enclosure.

Such a method, wherein sensing the one or more parameters associated with operation of the evaporative cooling system comprises sensing one or more of: humidity; temperature; pressure; and airflow and water droplet size and quantity.

Such a method, further comprising providing one or more user control signals to a controller; generating, by the controller, one or more control signals based at least in part on the received user control signals; and providing the control signals to at least one of the atomizer and a fan that circulates the air through the enclosure.

As noted above, the housings in embodiments of the present invention can alternately be in a compacted state or an expanded state. For the purposes of this disclosure, terms such as “expanded”, “higher volume”, “increased-volume”, and the like may be used interchangeably to describe the expanded state in which the system operates. The compacted state that the system may be in when it is not operating may be referred to using interchangeable terms including “compacted”, compact”, “reduced-volume”, “lower volume”, and the like.

Another embodiment may include a method for providing evaporative cooling in an evaporative cooling system, the method comprising: drawing air through a fan; providing water to an atomizer positioned before or after the fan, wherein the atomizer receives water from a water source and generates a mist of the water within the airstream; and providing the cooled air from fan.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the disclosed embodiment.

What is claimed is:

1. An evaporative cooling system comprising:
an enclosure;
an air inlet that enables air to flow from an exterior of the enclosure to an interior of the enclosure;
an air outlet that enables air to flow from the interior of the enclosure to the exterior of the enclosure;
a mist source positioned within the enclosure, wherein the mist source receives water from a water source and generates a mist of the water within the enclosure, wherein air from the air inlet is passed through the enclosure and thereby cooled by evaporation of the mist, and the cooled air is provided at the air outlet; and
a controller operatively coupled to the cooling system, wherein the controller generates one or more control signals that control the operation of the cooling system.

2. The evaporative cooling system of claim 1, wherein the controller is configured to control a rate at which the mist source injects the mist into the enclosure.

3. The evaporative cooling system of claim 1, further comprising a fan configured to move air through the enclosure from the air inlet to the air outlet, wherein the one or more control signals control operation of the fan.

4. The evaporative cooling system of claim 3, wherein the controller is configured to control a rate or volume at which the fan causes air to flow through the enclosure.

5. The evaporative cooling system of claim 1, further comprising at least one of a vent, a door, and a bypass for selectively causing air to flow throughout different sections of the enclosure, inlets, or outlets, wherein the controller is configured to control the at least one of the vent, door, and bypass.

6. The evaporative cooling system of claim 1, further comprising one or more sensors operatively coupled to the controller, wherein each of the sensors senses a corresponding parameter associated with operation of the evaporative cooling system and provides a corresponding sensor signal as an input to the controller, and wherein the controller generates the one or more control signals based at least in part on the received sensor signals.

7. The evaporative cooling system of claim 6, wherein at least one of the one or more sensors is configured to sense humidity.

8. The evaporative cooling system of claim 6, wherein at least one of the one or more sensors is configured to sense temperature.

9. The evaporative cooling system of claim 6, wherein at least one of the one or more sensors is configured to sense pressure.

10. The evaporative cooling system of claim 6, wherein at least one of the one or more sensors is configured to sense airflow.

11. The evaporative cooling system of claim 6, wherein at least one of the one or more sensors is configured to sense water level in a water source.

12. The evaporative cooling system of claim 6, wherein at least one of the one or more sensors is configured to sense parameters of the generated mist such as size, velocity, direction, and quantity of water mist droplets.

13. The evaporative cooling system of claim 6, wherein the one or more sensors comprise a plurality of sensors, wherein a first portion of the plurality of sensors is configured to sense parameters corresponding to conditions internal to the enclosure and a second portion of the plurality of sensors is configured to sense parameters corresponding to conditions external to the enclosure.

14. The evaporative cooling system of claim 1, further comprising one or more user controls operatively coupled to the controller, wherein each of the user controls provides a corresponding user control signal as an input to the controller, wherein the controller generates the one or more control signals based at least in part on the received user control signals.

15. An evaporative cooling system comprising:
a fan for creating air flow;
a mist source positioned proximate the fan for receiving water from a water source and generating a mist of water into the air flow created by the fan; and
a controller coupled to the fan and atomizer, wherein the controller generates one or more control signals that control the operation of the atomizer and fan.

16. The evaporative cooling system of claim 15, wherein the controller is configured to control a rate at which the mist source injects the mist into the air flow.

17. The evaporative cooling system of claim 15, wherein the controller is configured to control a rate or volume at which the fan causes air to flow.

18. The evaporative cooling system of claim 15, further comprising one or more sensors operatively coupled to the controller, wherein each of the sensors senses a corresponding parameter associated with operation of the evaporative cooling system and provides a corresponding sensor signal as an input to the controller, and wherein the controller generates the one or more control signals based at least in part on the received sensor signals.

19. The evaporative cooling system of claim 18, wherein at least one of the one or more sensors is configured to sense one or more of humidity, temperature, pressure, and airflow.

20. A method of controlling an evaporative cooling system having an enclosure, an air inlet that enables air to flow from an exterior of the enclosure to an interior of the enclosure, an air outlet that enables air to flow from the interior of the enclosure to the exterior of the enclosure, a mist source positioned within the enclosure, and a controller, the method comprising:
sensing a plurality parameters of the evaporative cooling system; and
controlling, using the controller, the operation of the evaporative cooling system based on sensed parameters of the evaporative cooling system.

21. An evaporative cooling system comprising:
an enclosure;
an air inlet that enables air to flow from an exterior of the enclosure to an interior of the enclosure;
an air outlet that enables air to flow from the interior of the enclosure to the exterior of the enclosure;
one or more evaporative media positioned within the enclosure;
a water distribution subsystem positioned within the enclosure, wherein the water distribution subsystem receives water from a water source and delivers water to the one or more evaporative media; and
a controller operatively coupled to the cooling system, wherein the controller generates one or more control signals that control the operation of the cooling system.
